(19) United States
(12) Patent Application Publication
(10) Pub. No.: US 2016/0321858 A1
(43) Pub. Date: Nov. 3, 2016

(54) Method, system and portable digital media for processing an interactive game of chance

(71) Applicant: Michael Matthew Sydenham, Ashmore (AU)

(72) Inventor: Michael Matthew Sydenham, Ashmore (AU)

(21) Appl. No.: 14/998,822

(22) Filed: Apr. 19, 2015

(51) Int. Cl. G07F 17/32

(52) U.S. Cl. CPC G07F 17/3211; G07F 17/3244; G07F 17/329

(57) ABSTRACT

A method, system and portable digital media for processing an interactive game of chance enables an alternative gambling experience. The method includes coupling a portable digital media, including the interactive game of chance, with a consumer device; viewing visual components of the interactive game of chance, wherein the visual components are used to define a predetermined outcome of the interactive game of chance; interacting with the visual components through the consumer device; and viewing the predetermined outcome of the interactive game of chance.

### FIELD OF THE INVENTION

The present invention relates to gambling. In particular, although not exclusively, the invention relates to remote gambling.

### BACKGROUND TO THE INVENTION

There is a substantial segment of the world population that enjoys wagering responsibly on various games of chance for entertainment purposes. There are a considerable number of wagering options including visiting purpose-built facilities (such as pubs, clubs, casinos and bingo halls), and using online wagering sites through a personal computer connected to the internet.

There are however several disadvantages of the wagering options mentioned above, especially for those who wish to wager on games of chance from home. For example, a computer and an internet connection of sufficient capability are needed. Some gamblers may only have a standalone computer without an internet connection, or may be unable or unwilling to connect to the Internet. Additionally, local laws or regulations may prohibit a person from participating in online wagering. A further disadvantage is that the gambler may not have a level of comfort to access and navigate various web sites to perform any necessary software installation, player registration, and funds management to enable playing online games with confidence.

A further aspect of online wagering relates to payment, or a depositing of funds to enable game play. This is usually performed online at the wagering web site and is often facilitated by a third party service. A disadvantage of this system is that a significant level of security awareness and a familiarity with performing online transactions is required. Additionally, a credit card is generally required as cash cannot be used.

Another disadvantage with online wagering is that all wagering goes through one or more wagering servers, enabling others to track a gambler's behaviour in great detail.

A disadvantage with credit card based wagering services is that there is little to no control over a gambler's expenditure. When credit cards are used as a purchasing medium online, for example, problems with greater than planned expenditure and the problems related therewith typically increase.

Lottery tickets are a popular form of gambling that may be enjoyed at home, without the need for a computer or internet. A disadvantage, however, is that lottery ticket results are revealed at a set time which cannot be controlled by the user and are delivered in a strictly limited and predefined format.

Scratch cards are another popular form of gambling where a user may gamble at home, or otherwise, at a time of his or her choice. Scratch cards have the disadvantage of being “static” as they are printed on a card, as opposed to the lights, music, animation and/or video which may be present online and at purpose-built gambling facilities.

Recordings of gambling experiences, e.g. recordings of slot machines in action, are available for viewing at home, for example on a DVD player. Such recordings lack however an interactive component which is present when actually gambling, as one is simply viewing a recording of a gambling session.

Some or all of the abovementioned disadvantages may present barriers that can frustrate a player who wants to experience a genuine and fair wagering experience in the comfort of their home, at a time of their choosing and with safeguards on their wagering expenditure.

There is therefore a need to overcome or alleviate many of the above discussed disadvantages associated with gambling of the prior art.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to one aspect, the invention resides in a method of processing an interactive game of chance, including:

coupling a portable digital media, including said interactive game of chance, with a consumer device;

viewing visual components of said interactive game of chance, wherein said visual components are used to define a predetermined outcome of said interactive game of chance;

interacting with said visual components through said consumer device; and

viewing said predetermined outcome of said interactive game of chance.

Preferably, said method further includes redeeming a prize based upon said predetermined outcome.

Preferably, said interactive game of chance includes a virtual scratch card, said visual components include a plurality of scratch panels, and interacting with said visual components includes simulating scratching said plurality of scratch panels.

Preferably, said interactive game of chance includes a virtual slot machine, said visual components include reels of said virtual slot machine, and said step of interacting includes at least one of selecting a bet size, selecting a payline and initiating spinning of said reels.

Preferably, said interactive game of chance includes a virtual card game, said visual components include cards of said virtual card game, and said step of interacting includes at least one of selecting a bet size, and selecting cards to be held, discarded or drawn.

Preferably, said interactive game of chance includes a starting point including said visual components of said interactive game, and an end point including said predetermined outcome, wherein said interactive game comprises traversing one pathway of a plurality of pathways between said starting point and said end point, said one pathway dependent on said step of interacting with said visual components.

Preferably, said one pathway between said starting point and said end point is skill dependent.

Preferably, said method further includes selecting said interactive game from a plurality of interactive games, wherein said plurality of interactive games all include said predetermined outcome.

According to a further aspect, the invention resides in a portable digital media containing digital instructions, executable by a consumer device, for:

displaying visual components of an interactive game of chance, wherein said visual components are used to define an outcome of said interactive game of chance;

processing an interaction between a user and said visual components through said consumer device; and

displaying at least one predetermined outcome of said interactive game of chance, wherein said predetermined outcome is independent of said interaction.

Preferably, said predetermined outcome is associated with a prize.

Preferably, said portable digital media further includes a tamper resistant packaging.

Preferably, said predetermined outcome is written on an outer surface of said portable media.

Preferably, said predetermined outcome written on said outer surface is coded.

Preferably, said predetermined outcome written on said outer surface is not visible through said tamper resistant packaging.

Preferably, said predetermined outcome is linked at purchase to at least one of a person, a credit card, and an account.

Preferably, said portable digital media comprises a Digital Versatile Disc (DVD) and said digital instructions are recorded in video mode.

Preferably, said digital instructions comprise a virtual-machine menu and a plurality of video titles, wherein said interaction comprises selecting a component of said virtual-machine menu, and said digital instructions result in a display of a video title of said plurality of video titles based upon said component that was selected.

Preferably, said digital instructions comprise a first level virtual-machine menu, a plurality of second level virtual-machine menus, a plurality of first level video titles, and a plurality of second level video titles, wherein said interaction comprises selecting a first component of said first level virtual-machine menu and selecting a second component of a second level virtual-machine menu of said plurality of second level virtual-machine menus, wherein said digital instructions result in displaying a video of said plurality of first level video titles and said second level virtual-machine menu based upon said first component that was selected and displaying a video of said plurality of second level video titles based upon said second component that was selected.

Preferably, said portable digital media consists of one of the following: a USB memory, a DVD, a solid state memory device, a flash memory device, a memory stick, a smart media card, a secure digital card.

Preferably, digital instructions comprise a computer program.

According to a further aspect, the invention resides in a system for generating a portable digital media including an interactive game of chance, including:

an outcome generator, which generates an outcome for an interactive game of chance;

an interactive game of chance resource including visual components;

a game generator, which generates said interactive game of chance from said interactive game of chance resource and said outcome, wherein said outcome is displayed using said visual component of said interactive game of chance resource; and

a game recorder, which records said interactive game of chance to a portable digital media.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1A shows a screen shot of an interactive game of chance in the form of a scratch card according to an embodiment of the present invention;

FIG. 1B shows another screen shot of the scratch card of FIG. 1A where a scratch panel has been scratched;

FIG. 1C shows yet another screen shot the scratch card of FIG. 1A where all scratch panels have been scratched and a winning outcome is displayed;

FIG. 1D shows yet another screen shot the scratch card of FIG. 1A where all scratch panels have been scratched and a losing outcome is displayed;

FIG. 2 shows a flow diagram of the processing of an interactive game by a consumer device;

FIG. 3 shows screen shot of an interactive game of chance in the form of a slot machine according to an embodiment of the present invention;

FIG. 4 shows a flow diagram of the processing of an interactive game in the form of a scratch card on a DVD, by a DVD player;

FIG. 5 shows a DVD structure of a plurality of interactive games of chance stored on a single DVD,

FIG. 6 shows a portable digital media including an interactive game of chance according to an embodiment of the present invention;

FIG. 7 shows a digital media. including a tamper resistant packaging, according to an embodiment of the present invention;

FIG. 8 illustrates a system for generating digital media including a game of chance according to an embodiment of the present invention; and

FIG. 9 shows a flow diagram of a method of processing an interactive game of chance.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise gambling systems, methods and media. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

In one aspect, the invention resides in a method for remote gambling. The method includes coupling a portable digital media, including an interactive game of chance, with a consumer device; viewing visual components of said interactive game of chance, wherein said visual components are used to define a predetermined outcome of said interactive game of chance: interacting with said visual components through said consumer device; and viewing said predetermined outcome of said interactive game of chance.

Advantages of some embodiments of the present invention include the ability to gamble at a time and place of choice, without needing a computer with an internet connection of a particular capability, without needing to register an identification, without needing a credit card, and with the privacy of not allowing others to track gambling behaviour in great detail. Further embodiments of the present invention include an interactive component that gives the user the feeling and excitement associated with gambling in real time and determining or changing a final outcome. Additionally, the portable digital media enables an enhanced multimedia experience including audio and visual effects, and an ability to have a long gaming session in a small format.

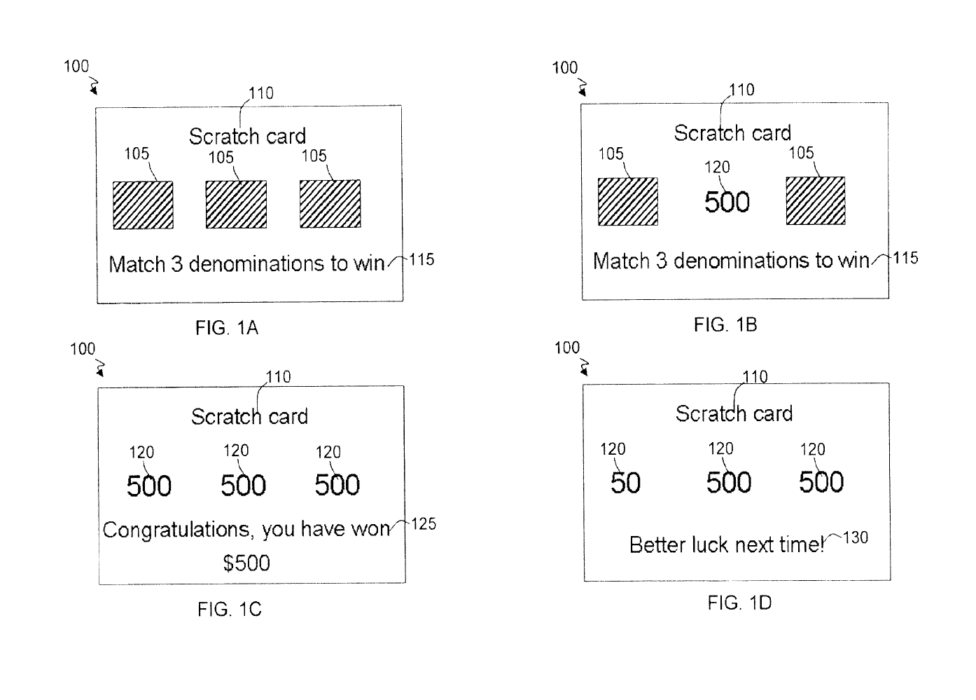

FIG. 1A shows a screen shot of an interactive game of chance in the form of a scratch card 100 according to an embodiment of the present invention. The scratch card 100 includes a plurality of visual components including scratch panels 105, a brand identifier 110 and instructions 115. The scratch panels are used to define a predetermined outcome of the interactive game of chance. The scratch panels are ‘scratched’ through an electronic interaction revealing the predetermined outcome.

As is understood by a person skilled in the art, several other visual components may be present in a scratch card 100, and neither the brand identifier 110 nor instructions 115 need be present on the scratch card 100. Furthermore, as is understood by one skilled in the art, any number of scratch panels 105 may be present on the scratch card 100, as may any number of prize panels or prize-multiplier panels.

FIG. 1B shows another screen shot of the scratch card 100 where a scratch panel 105 has been scratched, i.e. a user has interacted with the scratch panel 105 by scratching it. An outcome component 120 of the scratch card 100 is revealed. As is understood by one skilled in the art, no actual scratching is performed, but scratching is simulated. Forms of simulated scratching include simply revealing an outcome component 120, and removing the scratch panel 105 in a manner such that the outcome component 120 is revealed in a gradual manner. Alternatively, flashes or other animations may be used to simulate scratching that may typically not be associated with real scratching.

FIG. 1C shows another screen shot of the scratch card 100 where all scratch panels 105 have been ‘scratched’ and a winning outcome is displayed. The winning outcome is displayed both as a combination of the outcome components 120, and as a further winning message 125. As is understood by one skilled in the art, the winning outcome need only be displayed in a single form.

The outcome component 120 and/or winning message 125 is associated with a prize. For example, the outcome component 120 may indicate a monetary value that is redeemable from an agent, or from where the scratch card 100 was purchased. Other examples of prizes include further games of chance, material prizes or any other type of reward or prize.

FIG. 1D shows another screen shot of the scratch card 100 where all scratch panels 105 have been ‘scratched’ and a losing outcome is displayed. The losing outcome is displayed both as a combination of the outcome components 120, and as a further losing message 130. As is understood by one skilled in the art, the losing outcome need only be displayed in a single form.

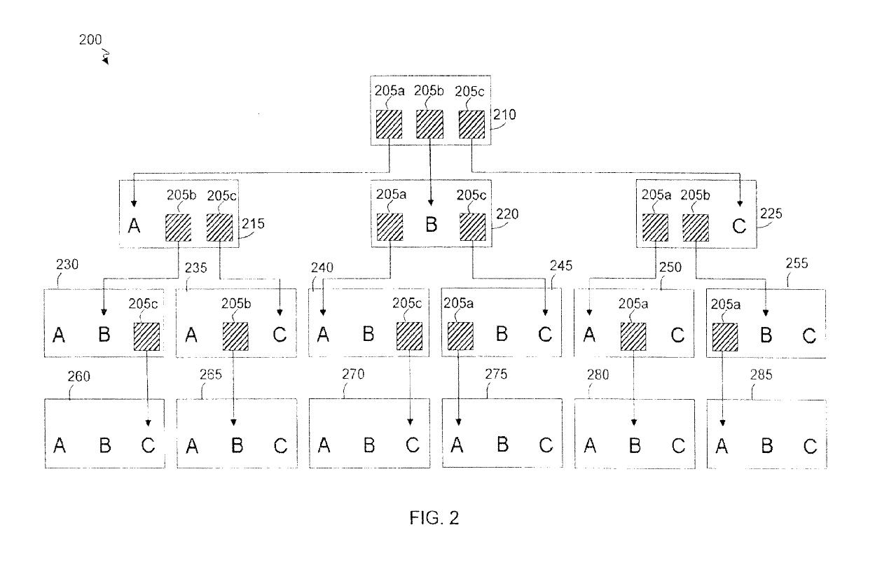

FIG. 2 shows a flow diagram 200 of the processing of an interactive game by a consumer device. The consumer device may be in the form of a DVD player with a remote control, or a personal computer with a computer input, for example. For the sake of clarity, the embodiment described herein is described in the context of the DVD player with the remote control, but as is understood by one skilled in the art the flow could easily be adapted to suit other device types.

In use, a user couples a portable digital media, in the form of a DVD, with a consumer device, in the form of a DVD player. Visual components of the scratch card are displayed on a screen of the device, or a screen connected to the device. The only visual components shown in FIG. 2 are scratch panels 205a, 205b, 205c, but as is understood by a person skilled in the art other visual components may be present. Initially all scratch panels 205a, 205b, 205c are shown to be unscratched as shown in state 210. A user interaction between the user and the scratch panels 205a, 205b, 205c may occur through a remote control of the DVD player. The user interacts with the scratch panels 205a, 205b, 205c by selecting a scratch panel 205a, 205b, 205c to be scratched, for example by using navigation buttons and an OK/ENTER button on the remote control. From state 210, the user may choose to scratch the scratch panel 205a, 205b or 205c which results in a transfer to state 215, 220, or 225 respectively.

From state 215, the user may choose to scratch the scratch panel 205b or 205c which results in a transfer to state 230, or 235 respectively. From state 220, the user may choose to scratch the scratch panel 205a or 205c which results in a transfer to state 240, or 245 respectively. From state 225, the user may choose to scratch the scratch panel 205a or 205b which results in a transfer to state 250, or 255 respectively.

At states 230, 235, 240, 245, 250 and 255, only a single scratch panel 205a, 205b, 205c is remaining. Upon scratching the remaining scratch panel 205a, 205b, 205c, the state is transferred from state 230, 235, 240, 245, 250 or 255 to state 260, 265, 270, 275, 280 or 285 respectively.

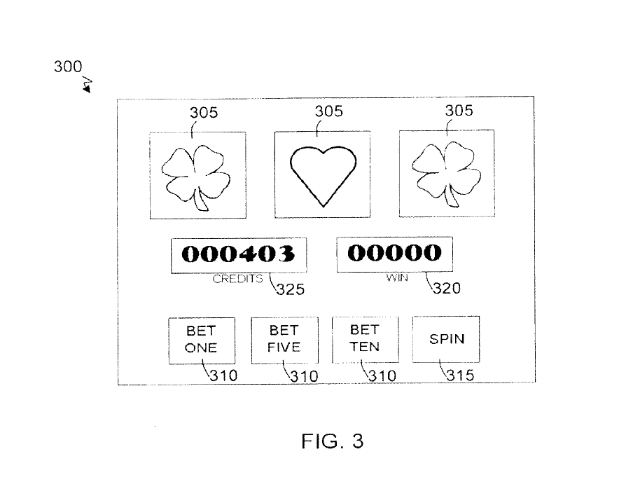

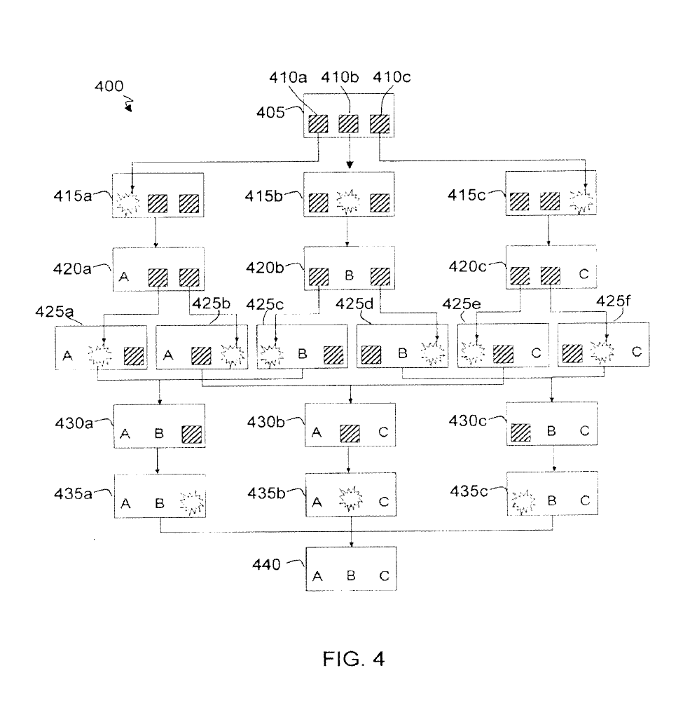

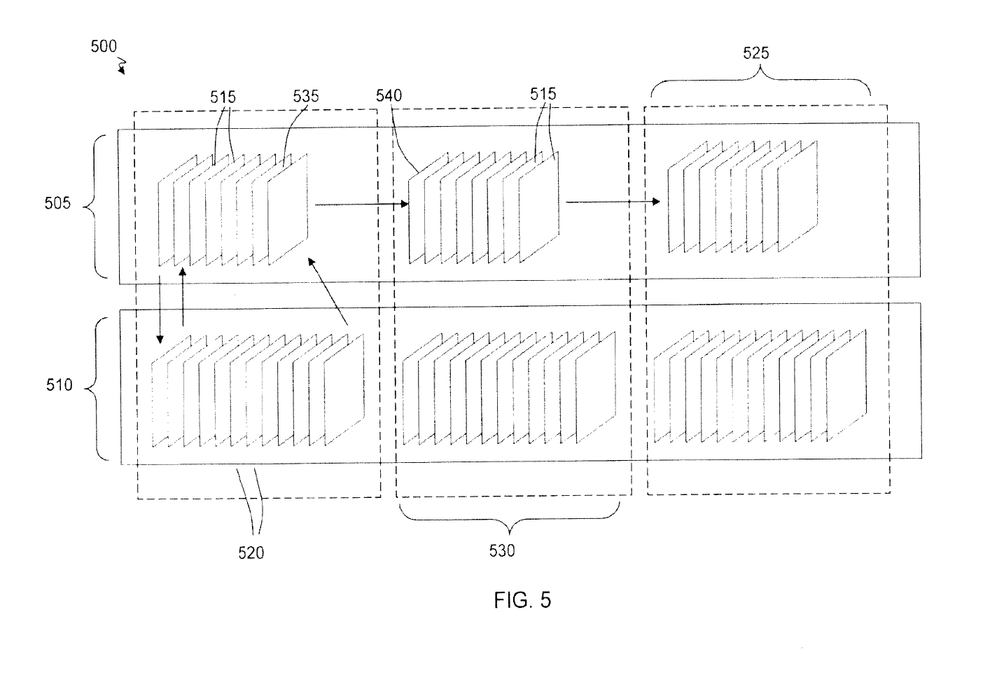

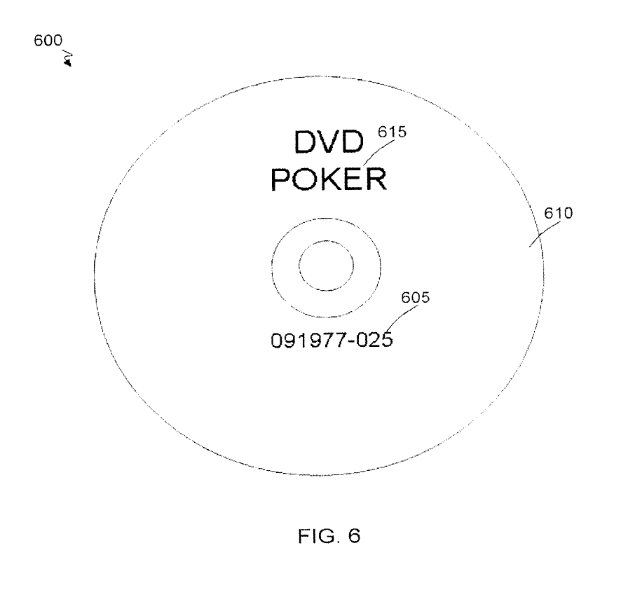

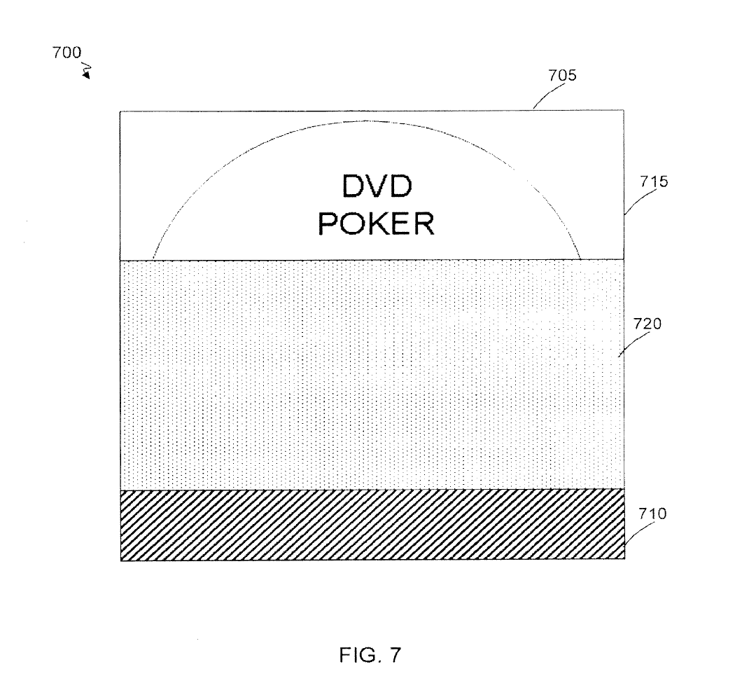

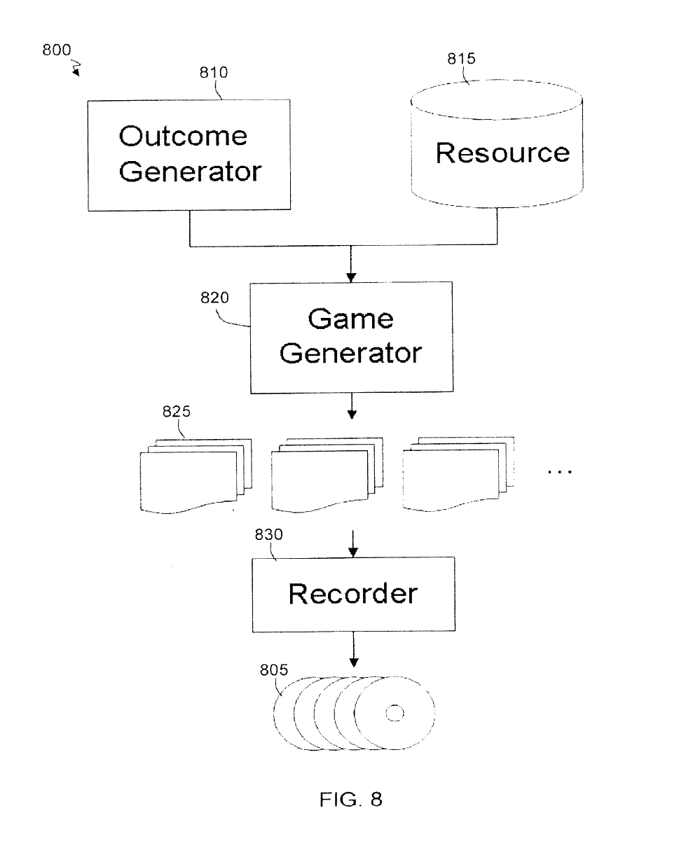

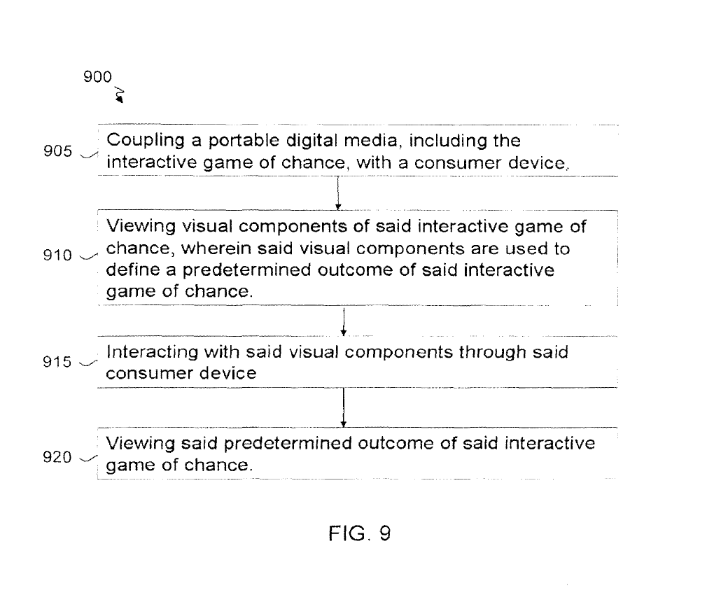

FIG. 3 shows screen shot of an interactive game of chance in the form of a slot machine 300 according to an embodiment of the present invention. The slot machine 300 includes a plurality of visual components including reels 305, bet size selection buttons 310, a spin button 315, an outcome panel 320 and a credits panel 325.

A gaming session may include playing the slot machine 300 multiple times. The gaming session may include a predetermined amount of slot machine plays, or a variable amount of slot machine plays selectable by a user.

A bet size is selected using the bet size selection buttons 310. In this embodiment, one, five or ten credits may be chosen, but as is understood by a person skilled in the art, any number of bet selection buttons 310, having any values, may be used. The user may be given a predetermined amount of credits, and the variable amount of slot machine plays is determined by the selected bet size. For example, a user betting one credit per game will get five times as many plays as a user betting five credits per game.

As the outcome is predetermined, the choice of bet size does not influence a final outcome of the slot machine 300. An outcome may be determined per slot machine play, i.e. the outcome is predetermined for each game played of a gaming session which also results in the final outcome being predetermined. Alternatively, only the final outcome is predetermined. In this case, to achieve a predetermined final outcome, a large win in an early game may be offset by a series of losses in later games.

The outcome, shown in FIG. 3 as a losing outcome, is displayed both as a combination of the reels 305, and as a win panel 320. As is understood by a person skilled in the art. the outcome need only be displayed in a single form.

The credits panel 325 displays a total number of credits. The total number of credits may be used to show accumulated winnings, credits remaining for play, or any other state of credits spanning over the slot machine plays.

As is understood by a person skilled in the art, the interactive game of chance could similarly include a virtual card game such as poker or

The claims defining the invention are as follows:

1. A method of processing an interactive game of chance, including:
coupling a portable digital media, including said interactive game of chance, with a consumer device;
viewing visual components of said interactive game of chance, wherein said visual components are used to define a predetermined outcome of said interactive game of chance;
interacting with said visual components through said consumer device; and
viewing said predetermined outcome of said interactive game of chance.

2. The method of claim 1 further including redeeming a prize based upon said predetermined outcome.

3. The method of claim 1, wherein said interactive game of chance includes a virtual scratch card, said visual components include a plurality of scratch panels, and interacting with said visual components includes simulating scratching said plurality of scratch panels.

4. The method of claim 1, wherein said interactive game of chance includes a virtual slot machine, said visual components include reels of said virtual slot machine, and said step of interacting includes at least one of selecting a bet size, selecting a payline and initiating spinning of said reels.

5. The method of claim 1, wherein said interactive game of chance includes a virtual card game, said visual components include cards of said virtual card game, and said step of interacting includes at least one of selecting a bet size, and selecting cards to be held, discarded or drawn.

6. The method of claim 1, wherein said interactive game of chance includes a starting point including said visual components of said interactive game, and an end point including said predetermined outcome, wherein said interactive game comprises traversing one pathway of a plurality of pathways between said starting point and said end point, said one pathway dependent on said step of interacting with said visual components.

7. The method of claim 6, wherein said one pathway between said starting point and said end point is skill dependent.

8. The method of claim 1 further including selecting said interactive game from a plurality of interactive games, wherein said plurality of interactive games all include said predetermined outcome.

9. A portable digital media containing digital instructions, executable by a consumer device, for:
displaying visual components of an interactive game of chance, wherein said visual components are used to define an outcome of said interactive game of chance;
processing an interaction between a user and said visual components through said consumer device; and
displaying at least one predetermined outcome of said interactive game of chance, wherein said predetermined outcome is independent of said interaction.

10. The portable digital media of claim 9, wherein said predetermined outcome is associated with a prize.

11. The portable digital media of claim 9, further including a tamper resistant packaging.

12. The portable digital media of claim 9, wherein said predetermined outcome is written on an outer surface of said portable media.

13. The portable digital media of claim 12, wherein said predetermined outcome written on said outer surface is coded.

14. The portable digital media of claim 12, wherein said predetermined outcome written on said outer surface is not visible through a tamper resistant packaging.

15. The portable digital media of claim 9, wherein said portable digital media comprises a Digital Versatile Disc (DVD) and said digital instructions are recorded in video mode.

16. The portable digital media of claim 15, wherein said digital instructions comprise a virtual-machine menu and a plurality of video titles, wherein said interaction comprises selecting a component of said virtual-machine menu, and said digital instructions result in a display of a video title of said plurality of video titles based upon said component that was selected.

17. The portable digital media of claim 16, wherein said digital instructions comprise a first level virtual-machine menu, a plurality of second level virtual-machine menus, a plurality of first level video titles, and a plurality of second level video titles, wherein said interaction comprises selecting a first component of said first level virtual-machine menu and selecting a second component of a second level virtual-machine menu of said plurality of second level virtual-machine menus, wherein said digital instructions result in displaying a video of said plurality of first level video titles and said second level virtual-machine menu based upon said first component that was selected and displaying a video of said plurality of second level video titles based upon said second component that was selected.

18. The portable digital media of claim 9, wherein said portable digital media consists of one of the following: a USB memory, a DVD, a solid state memory device, a flash memory device, a memory stick, a smart media card, a secure digital card.

19. The portable digital media of claim 18, wherein said digital instructions comprise a computer program.

20. A system for generating a portable digital media including an interactive game of chance, including:
an outcome generator, which generates an outcome for an interactive game of chance;
an interactive game of chance resource including visual components;
a game generator, which generates said interactive game of chance from said interactive game of chance resource and said outcome, wherein said outcome is displayed using said visual component of said interactive game of chance resource; and
a game recorder, which records said interactive game of chance to a portable digital media.
